(19) United States
(12) Patent Application Publication
(10) Pub. No.: US 2009/0188905 A1
(43) Pub. Date: Jul. 30, 2009

(54) Waterproof, electrically heated articles of apparel and methods of making same

(76) Inventor: Cole Williams, Bainbridge Island, WA (US)

Correspondence Address: JAMES E. BRUNTON, ESQ., P. O. BOX 29000, GLENDALE, CA, 91209, US

(21) Appl. No.: 12/012,155

(22) Filed: Jan. 30, 2008

(51) Int. Cl. A41D 19/00; H05B 3/34

(52) U.S. Cl. 219/211; 2/167; 2/169

(57) ABSTRACT

A waterproof, electrically heated, multi-layered article of apparel that is heated by a flexible heating harness that is disposed between the layers of the article and is constructed from silver-plated filaments. Uniquely, the flexible heating harness is sandwiched between a pair of waterproof bladders. The article of apparel has a plurality of heat zones with wattages and amperages required to heat the various zones of the hands to optimum temperatures as determined by the physiology of the human hand.

### BACKGROUND OF THE INVENTION

1. Field of the Invention

The present invention relates generally to electrically heated articles of apparel and methods of making the same. More particularly, the invention concerns a waterproof, electrically heated glove having a heating harness having variable heating characteristics that is encapsulated between a pair of waterproof bladders and the method of making the glove.

2. Discussion of the Prior Art

Various types of heated garments, including heated gloves have been suggested in the past. Batteries are typically used in these prior art garments to provide the source of electrical power to heat various types of heating elements, such as fine wires, that are embedded in the material from which the garment is fabricated. During use of the garment the heating elements are frequently subjected to undue stress that causes degradation and ultimate failure. Moreover, due to their bulk and lack of flexibility, the prior art garments are often cumbersome and uncomfortable in use. Additionally, because the length of the heating elements that, due to electrical resistance, heat the prior art garments, typically vary in length and, therefore, vary in resistance, the prior art garments are generally heated in an undesirable, uneven fashion.

It is an object of the present invention to provide a waterproof, electrically heated article of apparel that includes a plurality of strategically located heating zones that are heated by a novel, yieldably deformable heater harness that is formed from a plurality of thin, interconnected, electrically conductive yarn-like members that are constructed from silver-plated filaments. To protect the heater harness from water it is uniquely encapsulated between a pair of waterproof bladders.

### SUMMARY OF THE INVENTION

It is an object of the present invention to provide a waterproof, electrically heated, multi-layered article of apparel that is heated by a flexible heating harness that is disposed between the layers of the article and is constructed from silver-plated filaments. More particularly, it is an object of the invention to provide an article of apparel of the aforementioned character that comprises a controllably heated glove having variable heating characteristics that can be used for diving.

Another object of the invention is to provide an article of apparel as described in the preceding paragraph in which the flexible heating harness is sandwiched between a pair of waterproof bladders.

Another object of the invention is to provide a waterproof, battery powered, heated diving glove as described in the preceding paragraph that permits divers to maintain functionality of their hands in waters as cold as 0° Celsius for periods of up to 4 hours. In this regard it is an object of the invention to provide a diver's glove that has a plurality of heat zones with wattages and amperages required to heat the various zones of the hands to optimum temperatures as determined by the physiology of the human hand.

Another object of the invention is to provide a waterproof, electrically heated diving glove as described in the preceding paragraph in which the flexible heating harness is constructed from silver-plated yarn made up of a plurality of segmented heater rovings that are interconnected with a suitable electrical controller.

Another object of the invention is to provide a waterproof, electrically heated diving glove as described in the preceding paragraphs in which the flexible heating harness can effectively withstand the stresses caused by movement of the diver's hand.

Another object of the invention is to provide a waterproof, electrically heated article of apparel as described in the preceding paragraphs that exhibits substantially uniform stretch-and-return characteristics.

Another object of the invention is to provide a waterproof, electrically heated article of apparel of the class described in which the flexible heating harness comprises a plurality of rovings each made up of a multiplicity of silver-coated nylon filaments.

Another object of the invention is to provide an article of apparel of the character described that includes a controller assembly that is operably associated with the heating harness for controlling the temperature thereof.

Another object of the invention is to provide an electrically heated article of apparel as described in the preceding paragraphs that is easy to don, comfortable to wear and uniformly heats the portion of the user's body that is covered by the article of apparel.

Another object of the invention is to provide an electrically heated article of apparel of the class described that has the general shape of a human hand.

Another object of the invention is to provide an article of apparel as described in the preceding paragraphs that is attractive in appearance and highly reliable in use.

The forgoing as well as other objects of the invention will be realized by the inventions described more fully in the paragraphs that follow.

### BRIEF DESCRIPTION OF THE DRAWINGS

FIG. 1 is a generally perspective view of the palm side of one form of the waterproof, electrically heated glove of the invention.

FIG. 2 is a generally perspective view of the back side of the waterproof, electrically heated glove shown in FIG. 1.

FIG. 3 is a plan view of the back portion of the glove showing the heating harness sandwiched between the pair of waterproof bladders of the waterproof, electrically heated glove of the invention and showing the assemblage made up of the waterproof bladders and the heating harness sandwiched between the inner and outer liners of the glove and showing the entire assemblage in position over a rigid, generally hand-shaped mandrel.

FIG. 4 is a plan view of palm portion of the assemblage shown in FIG. 3.

FIG. 5 is a greatly enlarged, cross-sectional view taken along lines 5-5 of FIG. 4.

FIG. 6 is a top plan view illustrating the construction of one form of the heater harness component of the invention.

FIG. 7 is a front view of the heater harness component shown in FIG. 6.

FIG. 8 is a generally perspective, fragmentary view illustrating the manner in which the heater harness of the invention is interconnected with the electrical controller of the invention.

FIG. 9 is a greatly enlarged view of one form of the electrical controller of the invention.

FIG. 10 is a greatly enlarged, cross-sectional view taken along lines 10-10 of FIG. 8.

FIG. 11 is a side-elevational view of one form of the platen press assembly used in carrying out one form of the method of the invention.

FIG. 12 is a generally perspective view of one form of the waterproof, electrically heated sock of the invention.

FIG. 13 is a top plan view illustrating the construction of an alternate form of the heater harness component of the invention of the character embodied in the waterproof, electrically heated sock of the invention.

### DESCRIPTION OF THE INVENTION

As used herein, the following terms have the following meanings:

The term “fabric” as used herein means a material of any kind that is woven, spun, braided or knit from fibers, either manmade, or vegetable or animal.

The term “mandrel” as used herein means a rigid, generally planar, relatively thin support member having the general shape of an article of apparel.

The term “roving” as used herein means a long and narrow bundle of generally parallel fibers, or fibers with a twist to hold the fiber together.

The term “denier” as used herein means a unit of weight indicating the fineness of fiber filaments and yarns, both silk and synthetic, and equal to a yarn weighing one gram per each 9,000 meters used especially in indicating the fineness of women's hosiery.

The term “silver-plating” as used herein means a process for plating metallic silver onto an object, such as a process commonly known as “electroless plating.”

The term “plate” as used herein means to coat an object with a thin film of gold, silver, nickel, etc. by mechanical or chemical means.

The term “snap fastener” as used herein means a closure device consisting of a closure unit and attaching unit which, when interconnected, complete an electrical circuit.

The term “battery” as used herein means a device that stores chemical energy and makes it available in an electrical form.

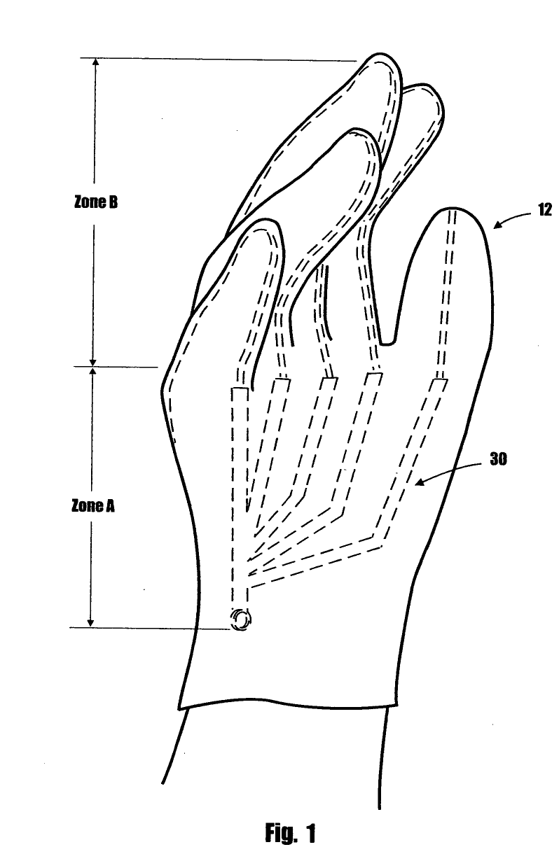

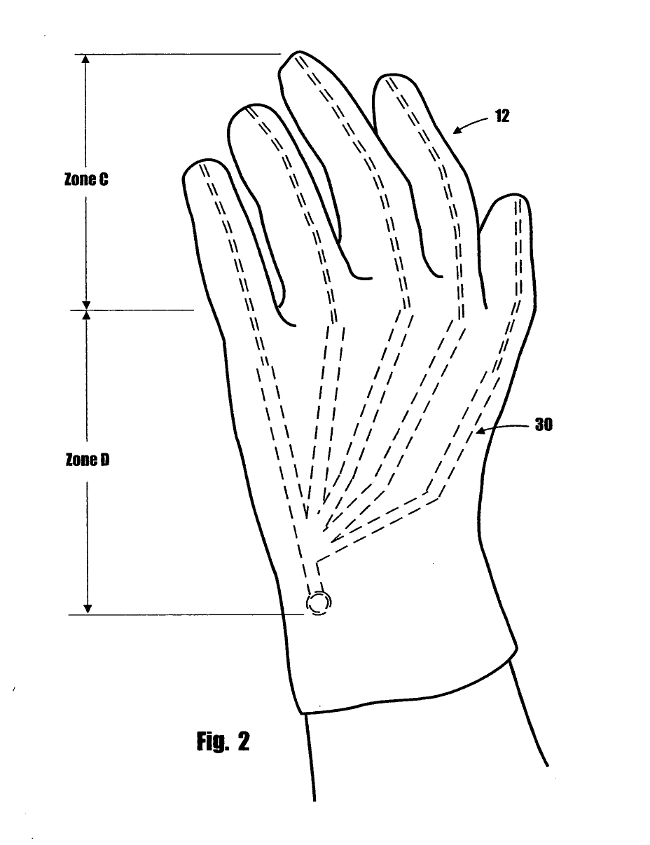

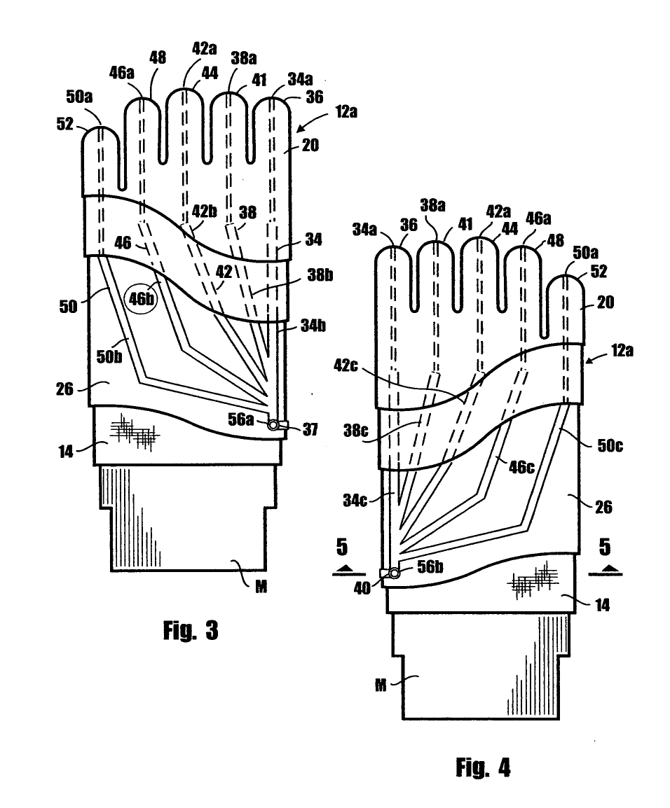

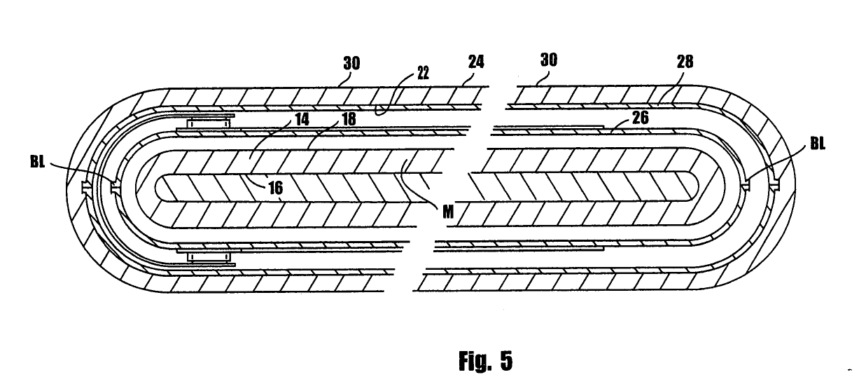

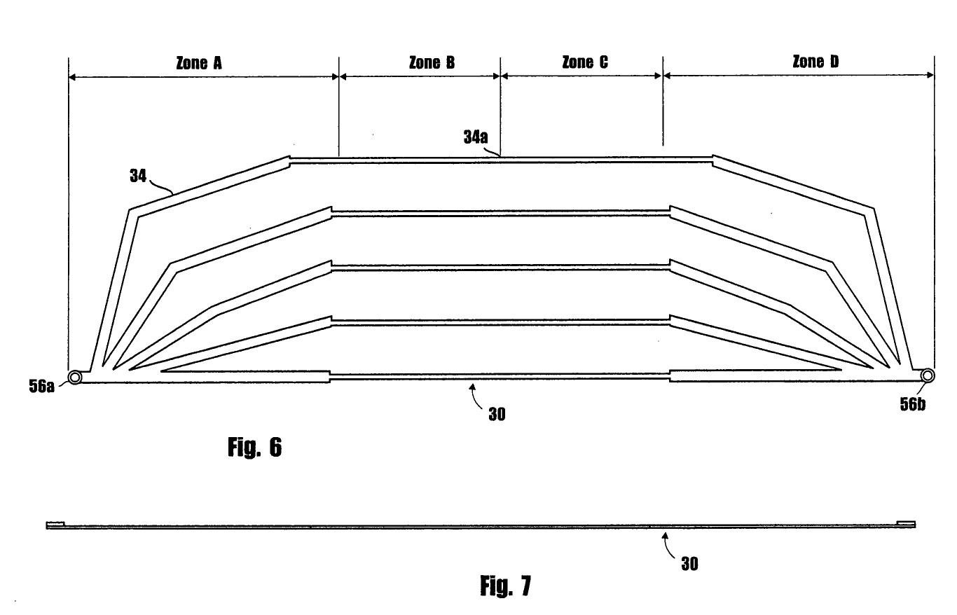

Referring now to the drawings, and particularly to FIGS. 1 and 2, one form of the electrically heated article of apparel of the present invention, here shown as a glove, is there illustrated and generally designated by the numeral 12. As best seen in FIGS. 3, 4 and 5, the electrically heated glove comprises a four-ply construction that includes a user-contact inner glove portion, or liner 14, having inner and outer surfaces 16 and 18 and an outer glove portion 20 having inner and outer surfaces 22 and 24. Disposed intermediate portions 14 and 20 is a pair of waterproof bladders 26 and 28 within which the electrical heater component 30 is encapsulated (See FIG. 5). The construction and a method of manufacture of the waterproof bladders will presently be described. In FIGS. 3 and 4, the precursor glove 12a is shown mounted on a relatively thin, generally hand-shaped aluminum mandrel “M”.

Glove portions 14 and 20 can be constructed in various ways from a number of different types of materials, including elastomers, composites and fabrics made by knitting and weaving processes well understood by those skilled in the art. However, the glove portions 14 and 20 of the present invention are preferably knit using a yarn sold by E. I. du Pont de Nemours and Company of Wilmington, Del. under the name and style NOMEX. For reasons presently to be described, the yarn preferably includes a Spandex core. Spandex comprises a long-chain synthetic polymeric fiber. Soft and rubbery segments of polyester or polyether polyols allow the fiber to stretch up to 600% and then recover to its original shape. Hard segments, usually urethanes or urethane-ureas, provide rigidity and so impart tensile strength and limit plastic flow. The knitting of the stretchable glove components 14 and 20 can be accomplished using various types of knitting machines, including machines made by Shima Seiki, Ltd., of Wakayama, Japan. It is to be understood that various types of natural as well as man-made synthetic fibers can be used to construct the glove components of the invention.

As illustrated in FIG. 6 of the drawings, the important electrical heater element, or harness component 30, of the invention here comprises a plurality of spaced-apart rovings, each of which is made up of silver (metal) plated nylon filaments, arranged in generally parallel bundles having different quantities of filaments. By way of example, zone A is made up of a first, high quantity of filaments giving it a low electrical resistance while zone B is made up of a second, lesser quantity of filaments giving it a higher electrical resistance. Zone C is made up of a third number of filaments giving it still a different electrical resistance and zone D is made up of a fourth number of filaments giving this zone yet another electrical resistance. At the junction of zones A and B, at the junction of zones B and C and at the junction of zones C and D an electrical connection is made to terminate and join together the various zones of the rovings. This electrical connection may be made by wrapping and tying the ends of the roving segments with strands of silver (metal) plated yarn, by stapling the ends together with a metal staple, by bonding the ends together with an electrical conducting adhesive, such as an epoxy, or by various other means well known by those skilled in the art. The purpose for these various zones or segments of varying quantities of silver (metal) plated yarns is to construct a heater element that provides varying amounts of heat to selected portions of the user's hand and fingers as may be required by the human physiology of the hands. The method by which the heating harness 30 is encapsulated within the waterproof bladders of the glove will be described more fully in the paragraphs that follow.

Referring particularly to FIG. 6 of the drawings, the elongated rovings are constructed to form a novel heater element or harness 30 that can be embodied in a diver's glove to form a heated glove. As indicated in FIG. 6 of the drawings, harness 30 has a plurality of heat zones with selected wattages and amperages that are required to appropriately heat the various zones of the hands of the diver to optimum temperatures as determined by the physiology of the human hand. More particularly, each of the elongated rovings depicted in FIG. 6 must exhibit a predetermined, varied electrical resistance along its length. In accordance with one form of the method of the invention, this is accomplished by constructing each roving from a plurality of distinct segments of different electrical resistivity, each segment being made up of a plurality of silver-plated filaments that have been intertwined in a manner to hold the filaments together. In this way, when the heater element is encapsulated within a pair of waterproof bladders, each segment of each roving can be strategically arranged to cover a selected portion of the diver's hand and thereby heat that portion of the hand to the desired temperature (see FIGS. 1, 2, 3, and 4) where each of the rovings comprises a plurality of heating segments of different resistivity, which, in the finished glove, are strategically positioned over the front and back of the user's hand (see FIGS. 3 and 4).

Considering now one form of the method of the invention for constructing the important waterproof bladders 26 and 28; in the paragraphs that follow the method of the invention for making only bladder 26 will be discussed with the understanding that the method of making bladder 28 is substantially identical. The first step in the construction of bladder 26 is accomplished by overlaying two thin sheets of thermo-plastic material of a character that will prevent penetration of liquid water. This material can be polyurethane, sometimes described as thermoplastic urethane, having a thickness of between about 0.001 inch and about 0.005 inch. A suitable material of this type is sold by Mylan Laboratories, Inc. of St. Albens, Vt. Other suitable materials include elastomers made from polyesters, polyamides, cellulose derivatives, polyacrylic acid and its holologs, natural or synthetic rubber with hydrophilic impurities, copolyozamides, polyureas, polyelectrolytes, polyphosphates, polyvinylamide, polyvinlacohol, polyether, and copolymers thereof, polythioether, polythioetherpolyether, copolyepichlorohydrin-ether, polysulphosphates, copolyesterether and derivatives or mixtures thereof.

The next step in the present form of the method invention is to deposit a heat-activated adhesive, such as an adhesive available from the EMS-Chemie Company of Supter, S.C., on the first surface of the membrane material to coat the first side of the membrane. The adhesive can be applied to the bladder material by spraying, brushing, rolling or any other suitable means. After the adhesive has been deposited on the bladder material, the adhesive is activated by passing an infrared heater over the surface of the first membrane so as to melt the heat-activated powdered adhesive so as to fuse the adhesive to the first surface of the member. Next, a heat-activated adhesive is deposited on the second surface of the membrane material to coat the second side of the membrane. This done the adhesive is activated by passing an infrared heater over the second surface of the first membrane so as to melt the heat-activated powdered adhesive so as to fuse the adhesive to the second surface of the first membrane and thereby form a first adhesive-coated membrane.

After formation of the first adhesive-coated membrane, the process described in the previous paragraph is repeated to form a second adhesive-coated membrane. Define on the sheets of material a line circumscribing the boundary of the bladder. This done, the first and second adhesive-coated membranes are marked with a boundary line that defines the desired shape of the generally hand-shaped bladder. Next, the first and second adhesive-coated membranes are heated along the boundary line to a temperature sufficient to sealably bond the sheets together along the boundary line “BL” (see FIG. 5). The heating-fusion step can be accomplished in several ways well known to those skilled in the art, including using a heated wire or die having the shape of the bladder-boundary. Heating can also be accomplished through the use of well-known radio frequency and ultrasonic welding techniques.

One technique which has proven to be satisfactory in making the glove of the invention, involves the use of a conventional type of heated platen press of the characters shown in FIG. 11 of the drawings that includes an electrically heated die having the shape of the outer boundary of the bladders. Preferably, the die is electrically heated to about 500 degrees Fahrenheit. Appropriate heating of the dies causes the sheets of bladder material to be effectively welded, or sealably joined together along the boundary line “BL” to make the generally hand-shaped bladder 26. After the welding process, the excess material outside the bladder boundary is manually stripped away and the bladder is removed from the platen press. Following the construction of the bladder 26, the bladder 28 is constructed in substantially the same manner.

As illustrated in FIGS. 3 and 4 of the drawings, the next step in the process of the invention is to place the first covering member, or inner liner 14 over a generally hand-shaped, approximately ⅛th inch thick, generally planar mandrel “M” that is somewhat larger than the human hand and has disproportionately long fingers. Liner 14, which has inner and outer surfaces 16 and 18 is placed over the mandrel so that inner surface 16 thereof is disposed in engagement with the faces of the mandrel. As previously discussed, liner 14 can be constructed from a variety of materials. However, a liner which has been knit in a conventional manner using yarns that incorporate an elastic fiber with stretch characteristics, such as a yarn sold by DuPont under the name and style “LYCRA” has proven to be quite satisfactory for the intended purpose. With this liner construction, when the liner is placed over the mandrel “M” which is larger than the knit liner, the liner is stretched substantially to form a first sub-assembly. More particularly, in the present form of the invention, when liner 14 is in position over the mandrel, the palm and finger portions of the liner are extended on the order of between about 15% and about 40%.

The next step in this form of the method of the invention is to carefully place the bladder 26 over the first sub-assembly to form a second sub-assembly wherein the adhesive-coated inner surface of the bladder 26 is in close engagement with the fabric liner 14.

With the bladder 26 in position over the first sub-assembly, the electrical heater component 30 is carefully positioned over the bladder 26. More particularly, starting with the roving identified in FIG. 3 by the numeral 34, the fingertip junction 34a, that is, the junction between zone B and zone C (FIG. 6), is set at the tip 36 of the little finger portion of the bladder. This done, the roving is first extended longitudinally along the back of the little finger portion. Next, the back portion 34b of the roving (FIG. 3) is extended in substantially a straight line along the back portion of the bladder to a position 37 that is proximate the cuff portion on the back side of the glove. With roving 34 in this position, zone B extends along the back of the little finger portion of the bladder, while zone A extends across the back portion of the bladder. In a similar manner, the front portion 34c of the roving 34 (FIG. 4) is extended along the front portion of the bladder to a position 40 that is proximate the cuff portion on the front side of the bladder. With the roving 34 in this position zone D extends across the palm portion of the bladder, while zone C extends along the front of the little finger portion of the bladder.

In a similar fashion, the fingertip junction 38a, that is the junction between zone B and zone C (FIG. 6), is set at the tip 41 of the third finger portion of the bladder. This done, the roving is first extended longitudinally along the back of the third finger portion. Next, the back portion 38b of the roving 38 (FIG. 3) is extended along the back portion of the bladder in the manner illustrated in FIG. 3 to a position proximate position 37. With roving 38 in this position, zone B extends along the back of the third finger portion of the bladder, while zone A extends across the back portion of the bladder. In a similar manner, the front portion 38c of the roving 38 (FIG. 4) is extended along the front portion of the bladder to a position proximate position 40. With the roving 38 in this position zone D extends across the palm portion of the bladder, while zone C extends along the front of the third finger portion of the bladder.

Next, the fingertip junction 42a, that is the junction between zone B and zone C (FIG. 6), is set at the tip 44 of the second finger portion of the bladder. This done, the roving is first extended longitudinally along the back of the second finger portion of the bladder. This done, the back portion 42b of the roving 42 (FIG. 3) is extended along the back portion of the bladder in the manner illustrated in FIG. 3 to a position proximate position 38. With roving 42 in this position, zone B extends along the back of the third finger portion of the bladder, while zone A extends across the back portion of the bladder. In a similar manner, the front portion 42c of the roving 42 (FIG. 4) is extended along the front portion of the bladder to a position proximate position 40. With the roving 42 in this position zone D extends across the palm portion of the bladder, while zone C extends along the front of the second finger portion of the bladder.

Continuing with this form of the method of the invention, the fingertip junction 46a, that is the junction between zone B and zone C (FIG. 6), is set at the tip 48 of the index finger portion of the bladder. This done, the roving is first extended longitudinally along the back of the index finger portion of the bladder. This done, the back portion 46b of the roving 46 (FIG. 3) is extended along the back portion of the bladder in the manner illustrated in FIG. 3 to a position proximate position 38. With roving 46 in this position, zone B extends along the back of the index finger portion of the bladder, while zone A extends across the back portion of the bladder. In a similar manner, the front portion 46c of the roving 46 (FIG. 4) is extended along the front portion of the bladder to a position proximate position 40. With the roving 46 in this position zone D extends across the palm portion of the bladder, while zone C extends along the front of the index finger portion of the bladder.

In a similar manner, the thumb junction 50a, that is the junction between zone B and zone C (FIG. 6), is set at the tip 52 of the thumb portion of the bladder. This done, the roving is first extended longitudinally along the back of the thumb portion of the bladder. This done, the back portion 50b of the roving 50 (FIG. 3) is extended along the back portion of the bladder in the manner illustrated in FIG. 3 to a position proximate position 38. With roving 50 in this position, zone B extends along the back of the thumb portion of the bladder, while zone A extends across the back portion of the bladder. In a similar manner, the front portion 50c of the roving 50 (FIG. 4) is extended along the front portion of the bladder to a position proximate position 40. With the roving 50 in this position zone D extends across the palm portion of the bladder, while zone C extends along the front of the thumb portion of the bladder.

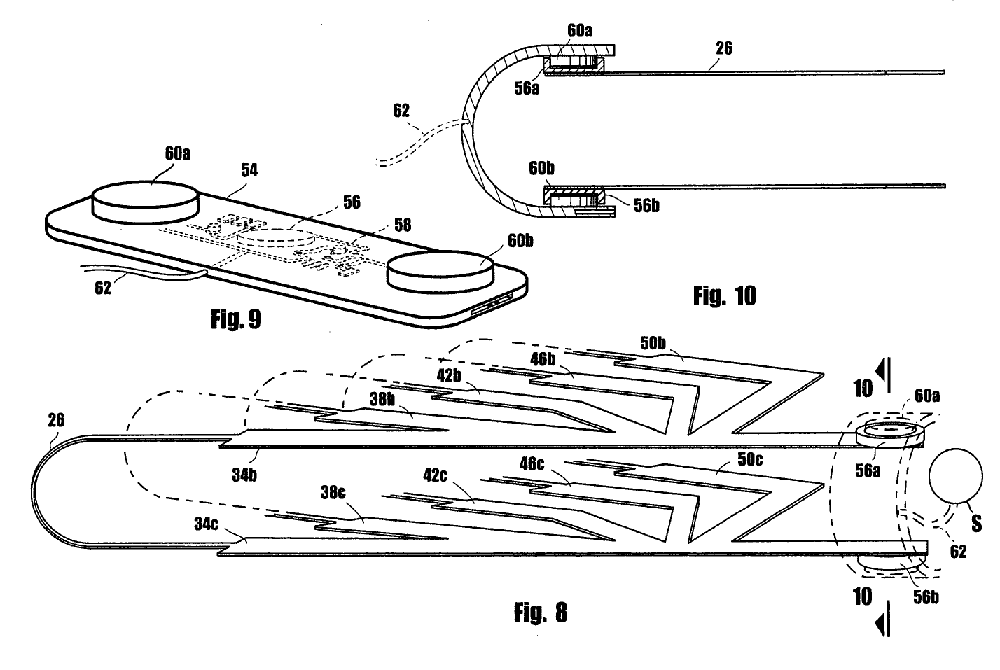

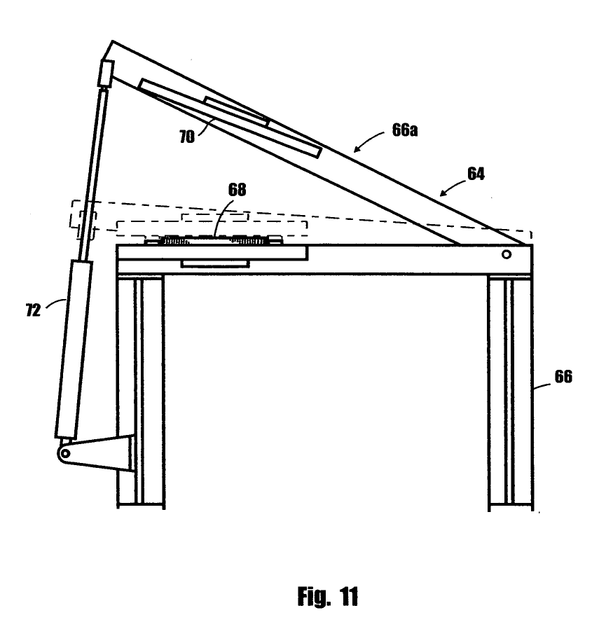

After the combination consisting of the mandrel “M”, the fabric liner 14, the adhesive-coated bladder 26 and the controller 54 has been positioned over the bladder 26 in the manner described in the preceding paragraphs, the next step in this form of the invention is to interconnect the controller assembly 54 with the electrical connectors 56a and 56b. As indicated in FIGS. 3 and 4 of the drawings, electrical connector 56a is located proximate location 37, while electrical connector 56b is located proximate location 40. As best seen by referring to FIG. 9 of the drawings, controller assembly 54 here comprises a battery 56 that is interconnected with a circuit board 58 that is, in turn, connected to electrical connectors 60a and 60b that are adapted to mate with electrical connectors 56a and 56b. When the electrical connectors are appropriately interconnected in the manner illustrated in FIGS. 8 and 10 of the drawings, electrical power can be supplied to the electrical heater component 30 to heat it to the desired elevated temperature as a result of the resistance caused by the uniquely constructed rovings 34, 38, 42, 46 and 50 that make up the electrical heater component 30. The nature and size of the battery 56 depends largely on the end-use to be made of the glove.

As illustrated in FIGS. 8 and 9, in one form of the invention the controller 54 can be interconnected via a conductor 62 and appropriate switching with an external source of electrical power “S” (FIG. 8) which may comprise a conventional DC power pack as, for example, a power pack carried about the waist of the user, or, alternatively, a source of alternating electrical current.

Following interconnection of the controller assembly 54 with the electrical connectors 56a and 56b, a fourth sub-assembly is formed by carefully positioning second adhesive-coated bladder 28 over the third sub-assembly that comprises the combination of the mandrel “M”, the fabric liner 14, the adhesive-coated bladder 26 and the controller 54. In this fourth sub-assembly, the second adhesive-coated bladder 26 overlays and is in close engagement with the electrical heater component 30.

To form the precursor electrically heated glove of the invention, the outer covering 20 is placed over the fourth sub-assembly that comprises the combination of the mandrel “M”, the fabric liner 14, the first adhesive-coated bladder 26, the controller 54 and the second adhesive-coated bladder 28. Next, the precursor electrically heated glove, which is of a character illustrated in FIGS. 3, 4 and 5 of the drawings, is controllably heated and compressed in a manner to urge the inner surface 22 of the outer covering 20 into engagement with the outer surface of the second adhesive-coated bladder 28, to urge the inner surface of the coated bladder 28 into engagement with the electrical heater component 30, to urge the electrical heater component 30 into engagement with the outer surface of the adhesive-coated bladder 26 and to urge the inner surface of adhesive-coated bladder 26 into engagement with the fabric liner 14. This important heating and compression step also activates the adhesive that is disposed on the surfaces of the bladders 26 and 28 so as to securely and simultaneously bond together the precursor electrically heated glove that is of a character illustrated in FIG. 5 of the drawings.

The heating and compression step can be accomplished in various ways well understood by those skilled in the art. However, this step is preferably accomplished using a conventional platen press 64 of the character illustrated in FIG. 11 of the drawings. Platen press 64 here comprises a supporting frame 66 to which a lower platen 68 is suitably affixed. Pivotally connected to frame 66 is a pivoting frame assembly 66a to which upper platen 70 is pivotally connected. At least one conventional air cylinder assembly 72 is connected to supporting frame 66 to controllably move the pivoting frame assembly 66a from the first open position to a second closed position. As is well understood by those skilled in the art, platens 68 and 70 are controllably heated to a temperature of approximately 375° F. by means of conventional electric resistance elements which are mounted in intimate contact with the platens. The temperature of each platen is continuously monitored by a suitable thermal controller of a character well known in the art (not shown) utilizing a thermocouple affixed to the platen (not shown).

As previously mentioned, this combination heating and compression step of the method of the invention activates the adhesive so as to securely and simultaneously bond together the various layers of the electrically heated glove and to uniquely encapsulate the electrical heating component 30 between the bladders 26 and 28 so as to provide a waterproof enclosure for the electrical heating component.

When removed from the mandrel, the electrically heated waterproof glove is generally planar in shape. However, upon inserting the hand into the open cuff of the article, the hand-engaging portion of the glove will neatly and smoothly conform to the shape of the wearer's hand. In this regard it is to be noted that during the accomplishment of the method of the invention, when the inner and outer knit layers 14 and 20 of the glove are positioned over the over-sized mandrel they are somewhat stretched. However, during this process, the silver-plated fibers that make up the heating harness remain relaxed. With this construction, when the glove is removed from the mandrel, the stretch in the inner and outer knit layers is relaxed and the silver-plated fibers that make up the heating harness are somewhat compressed. When the assembly-produced stretch is relaxed the silver-plated fibers are compressed somewhat. Accordingly, when the glove is worn the silver-plated fibers extend by straightening and, therefore, do not provide discomfort to the user as a user's hand is flexed.

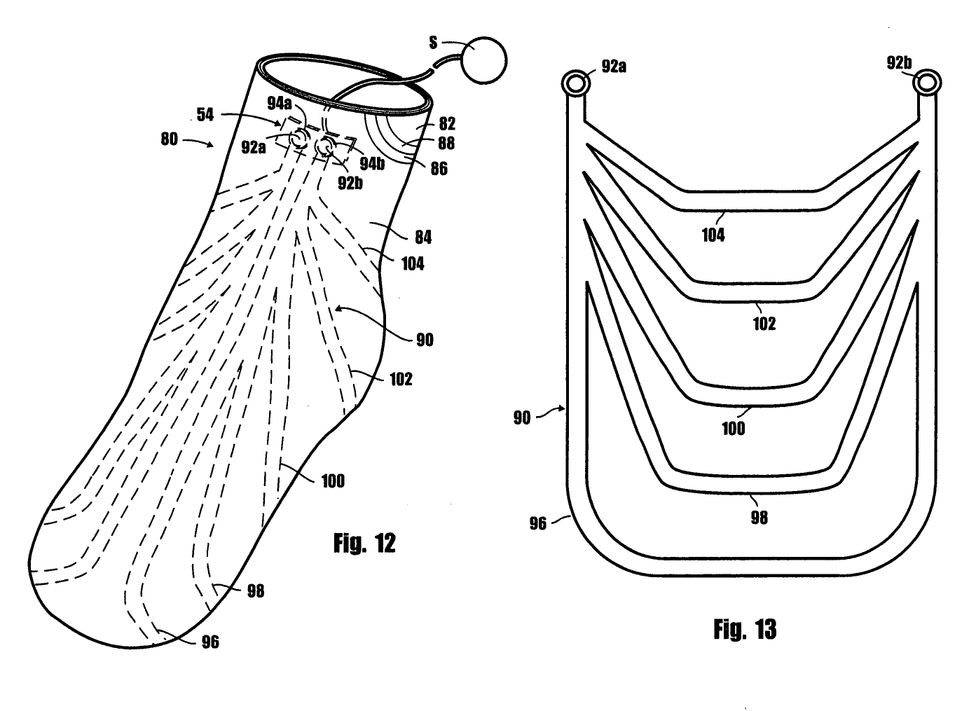

It is to be understood that the method of the invention can be used to produce various articles of clothing such as gloves of the character shown in FIGS. 1 and 2 of the drawings and such as socks of the character shown in FIG. 12 of the drawings. Such articles can be made in various sizes and design configurations to fit a wide variety of users.

Turning to FIG. 12, one form of the electrically heated, four-ply waterproof sock of the invention is there shown in generally designated by the numeral 80. The construction of sock 80 is similar in many respects to the construction of the previously described four-ply waterproof glove of the invention and here comprises a user-contact inner sock portion, or liner 82, having inner and outer surfaces and an outer sock portion 84. Disposed intermediate portions 82 and 84 is a pair of waterproof bladders 86 and 88 within which the electrical heater component 90 is encapsulated. The sock assembly of the invention also includes a controller assembly 54 that is substantially identical in construction and operation to the controller assembly previously described (see FIG. 9). As before, controller assembly 54 comprises a battery that is interconnected with a circuit board that is, in turn, connected to electrical connectors 92a and 92b that are adapted to mate with electrical connectors 94a and 94b (see FIG. 12). When the electrical connectors are appropriately interconnected in the manner illustrated in FIG. 12, electrical power can be supplied to the electrical heater component 90 to heat it to the desired elevated temperature as a result of the resistance caused by the uniquely constructed rovings 96, 98, 100 and 100, 102 and 104 that make up the electrical heater component 90 (see FIGS. 12 and 13).

The method of the invention for producing an electrically heated, four-ply waterproof sock 80, is substantially the same as the method described in the preceding paragraphs for making the electrically heated four-ply waterproof glove save that the mandrel and the various plies that make up the sock are generally foot-shaped rather than being generally hand-shaped.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An electrical heating apparatus for use in heating articles of apparel comprising a plurality of spaced-apart rovings, each roving having a plurality of interconnected segments, each segment comprising a different quantity of silver-plated filaments.

2. The apparatus as defined in claim 1 further including a controller assembly connected to said plurality of spaced-apart rovings.

3. The apparatus as defined in claim 1 in which said plurality of silver-plated filaments comprise silver-plated nylon filaments.

4. An electrically heated article of apparel comprising:
(a) an inner liner portion;
(b) an outer liner portion superimposed over said inner liner portion;
(c) a pair of waterproof bladders disposed between said inner liner portion and said outer portion; and
(d) an electrical heating harness disposed between said pair of waterproof bladders.

5. The article as defined in claim 4 in which said inner liner is constructed from fabric.

6. The article as defined in claim 4 in which said outer liner is constructed from fabric.

7. The article as defined in claim 4 in which each of said bladders is constructed from a polyurethane membrane.

8. The article as defined in claim 4 in which said heating harness comprises a plurality of spaced-apart rovings, each roving having a plurality of interconnected segments, each segment comprising a different quantity of silver-plated filaments.

9. The article as defined in claim 8 in which said plurality of silver-plated filaments comprise silver-plated nylon filaments.

10. The article as defined in claim 8 further including a controller assembly connected to said plurality of spaced-apart rovings for controllably heating said rovings.

11. An electrically heated glove comprising:
(a) an inner fabric liner portion;
(b) an outer fabric liner portion superimposed over said inner fabric liner portion;
(c) a pair of waterproof bladders disposed between said inner liner portion and said outer portion; and
(d) an electrical heating harness encapsulated between said pair of waterproof bladders, said electrical heating harness comprising a plurality of spaced-apart rovings, each roving having a plurality of interconnected segments, each segment comprising a different quantity of silver-plated filaments; and
(e) a controller assembly connected to said plurality of spaced-apart rovings for controllably heating said rovings.

12. The glove as defined in claim 11 in which each of said bladders is constructed from a polyurethane membrane.

13. The glove as defined in claim 11 in which said plurality of silver-plated filaments comprise silver-plated nylon filaments.

14. A method of making an electrically heated article of apparel comprising an inner liner portion having an inner surface and an outer surface, said method comprising the steps of:
(a) constructing a first bladder having an inner surface and an outer surface;
(b) interconnecting said first bladder with said inner liner portion to form a first sub-assembly;
(c) constructing a heating harness comprising a plurality of spaced-apart rovings, each roving having a plurality of interconnected segments, each segment comprising a different quantity of silver-plated filaments;
(d) interconnecting said heating harness with said outer surface of said first bladder of said first sub-assembly to form a second sub-assembly;
(e) constructing a second bladder having an inner surface and an outer surface;
(f) interconnecting said second bladder with said second sub-assembly to form a third sub-assembly in which said heating harness is sealed between said first and second bladders;
(g) constructing an outer liner having an inner surface and an outer surface;
(h) interconnecting said outer liner with said third sub-assembly to form a fourth sub-assembly; and
(i) interconnecting said heating harness of said second sub-assembly with a source of electrical power.

15. The method as defined in claim 14, including the further step of simultaneously heating and compressing said fourth sub-assembly.

16. The method as defined in claim 14 in which the electrically heated article of apparel comprises a glove.

17. A method of making an electrically heated article of apparel comprising an inner fabric liner having an inner surface and an outer surface, said method comprising the steps of:
(a) constructing a first adhesive-coated membrane from a first membrane having first and second surfaces by depositing a heat-activated adhesive on said first surface of said first membrane and depositing a heat-activated adhesive on said second surface of said first membrane;
(b) constructing from said first adhesive-coated membrane a first bladder having an inner surface and an outer surface;
(c) interconnecting said first bladder with said inner fabric liner to form a first sub-assembly;
(d) constructing a heating harness comprising a plurality of spaced-apart rovings, each roving having a plurality of interconnected segments, each segment comprising a different quantity of silver-plated filaments;
(e) interconnecting said heating harness with said outer surface of said first bladder of said first sub-assembly to form a second sub-assembly;
(f) constructing a second adhesive-coated membrane from a second membrane having first and second surfaces by depositing a heat-activated adhesive on said first surface of said second membrane and depositing a heat-activated adhesive on said second surface of said second membrane;
(g) constructing from said second adhesive-coated membrane a second bladder having an inner surface and an outer surface;
(h) interconnecting said second bladder with said second sub-assembly to form a third sub-assembly in which said heating harness is disposed between said first and second bladders;
(i) constructing an outer fabric liner having an inner surface and an outer surface;
(j) interconnecting said outer fabric liner with said third sub-assembly to form a fourth sub-assembly;
(k) interconnecting said heating harness of said second sub-assembly with a source of electrical power; and
(l) simultaneously heating and compressing said fourth sub-assembly to bond together said outer surface of said first fabric layer and said inner surface of said first bladder; to bond together said heating harness and said outer surface of said first bladder; to bond together said heating harness and said inner surface of said second bladder; and to bond together said outer surface of said second bladder and said inner surface of said outer fabric liner.

18. The method as defined in claim 17 in which said membrane comprises a polyurethane membrane.

19. The method as defined in claim 17 in which the electrically heated article of apparel comprises a glove.

20. The method as defined in claim 17 in which the electrically heated article of apparel comprises a sock.
